(19) United States
(12) Patent Application Publication
(10) Pub. No.: US 2020/0226188 A1
(43) Pub. Date: Jul. 16, 2020

(54) ADAPTIVE RECOMMENDATION SYSTEM AND METHOD FOR NETWORK-BASED CONTENT

(71) Applicant: Nokia Solutions and Networks Oy, Espoo (FI)

(72) Inventors: William Kennedy, Chelsea (CA); Gordon Wilfong, Portland, OR (US); Yihao Zhang, Chatham, NJ (US); Hung Nguyen, Pittsburgh, PA (US)

(21) Appl. No.: 16/247,483

(22) Filed: Jan. 14, 2019

(51) Int. Cl. G06F 16/9535; G06F 17/16; G06F 16/335; G06F 16/904

(52) U.S. Cl. CPC G06F 16/9535; G06F 16/904; G06F 16/337; G06F 17/16

(57) ABSTRACT

System, method, and software for recommending documents to users. A recommendation system identifies recent documents and historical information indicating consumption by users of past documents. The system generates a historical reading matrix based on the historical information, and generates a vector matrix for the recent documents and the past documents. The system generates an estimated reading matrix based on the historical reading matrix and the vector matrix, with the estimated reading matrix having first entries that represent actual reading scores for the past documents. The system calculates estimated reading scores for the recent documents based on the vector matrix, and populates second entries of the estimated reading matrix corresponding to the recent documents with the estimated reading scores. The system performs a factorization on the estimated reading matrix to generate a refined reading matrix, and generates recommendations of the recent documents based on the refined reading matrix.

### TECHNICAL FIELD

This disclosure relates to the field of computer networks, and more particularly to recommending network-based content to users.

### BACKGROUND

Computer networks, such as the Internet, provide users access to a variety of content, such as text-based documents (e.g., web pages, news articles, etc.), video, audio, or other types of content. Network-based content is generally referred to herein as electronic documents or documents. A typical user accesses the documents through an application (e.g., an email client, a web browser, etc.) on his/her computing device. For example, a web browser accesses web pages over a network connection, and displays the web pages to the user for viewing/reading. Each day, the volume of new documents available to a user over a computer network is massive, so systems may be developed that recommend certain documents to the user. For example, a web browser may generate a profile for a user based on a browsing history of the user, and recommend web pages to the user based on the profile. However, a static profile such as this may quickly become outdated as new topics, content, and reading patterns evolve. Therefore, it is desirable to identify improved ways of recommending documents to users.

### SUMMARY

Embodiments described herein provide a system, method, and software that recommend documents of interest to users. For example, a system as described herein uses a multi-step approach to construct a refined reading matrix that is used to provide recommendations of new documents that become available to users. For one step, the system constructs an estimated reading matrix that specifies a reading score for past documents (e.g., more than a month old) and for new or recent documents (e.g., published within the last month). The reading scores for the past documents are true scores, which means that the scores are based on actual reading by users. The reading scores for the recent documents are estimated by the system, such as using a cosine-averaged algorithm. For the second step, the system uses matrix decomposition on the estimated reading matrix to generate the refined reading matrix. This approach is advantageous in terms of processing speed so that real-time recommendations may be made to users. Another advantage is that the approach is adaptive in that the refined reading matrix evolves based on how the users read and/or score the recent documents, which subsequently transition to past documents over time. Thus, the refined reading matrix may be used to deliver more relevant documents to each user.

One embodiment comprises a recommendation system that comprises first circuitry configured to identify recent documents published within a time period preceding a present date, and to identify historical information indicating consumption by users of past documents that were published prior to the time period. The recommendation system further comprises second circuitry configured to generate a historical reading matrix based on the historical information, where the historical reading matrix has rows for the users, columns for the past documents, and entries that represent actual reading scores for the past documents. The second circuitry is further configured to generate a vector matrix for the recent documents and the past documents. The recommendation system further comprises third circuitry configured to generate an estimated reading matrix based on the historical reading matrix and the vector matrix, where the estimated reading matrix has rows for the users, columns for the past documents and the recent documents, and first entries that represent the actual reading scores for the past documents. In generating the estimated reading matrix, the third circuitry is configured to calculate estimated reading scores for the recent documents based on the vector matrix, and to populate second entries of the estimated reading matrix corresponding to the recent documents with the estimated reading scores. The recommendation system further comprises fourth circuitry configured to perform a factorization on the estimated reading matrix to generate a refined reading matrix. The recommendation system further comprises fifth circuitry configured to generate recommendations of the recent documents to the users based on the refined reading matrix.

In another embodiment, the third circuitry is configured to calculate the estimated reading scores for the recent documents using a cosine-averaged algorithm.

In another embodiment, the fourth circuitry is configured to use Nonnegative Matrix Factorization (NMF) to generate the refined reading matrix from the estimated reading matrix.

In another embodiment, the fourth circuitry is configured to use Singular Value Decomposition (SVD) to generate the refined reading matrix from the estimated reading matrix.

In another embodiment, the fourth circuitry is configured to use Lower-Upper (LU) decomposition to generate the refined reading matrix from the estimated reading matrix.

In another embodiment, the fifth circuitry is configured to present the recommendations of the recent documents to at least one of the users through a Graphical User Interface (GUI).

Another embodiment comprises a method of recommending documents to users. The method comprises identifying recent documents published within a time period preceding a present date, and identifying historical information indicating consumption by users of past documents that were published prior to the time period. The method further comprises generating a historical reading matrix based on the historical information, where the historical reading matrix has rows for the users, columns for the past documents, and entries that represent actual reading scores for the past documents. The method further comprises generating a vector matrix for the recent documents and the past documents. The method further comprises generating an estimated reading matrix based on the historical reading matrix and the vector matrix, where the estimated reading matrix has rows for the users, columns for the past documents and the recent documents, and first entries that represent the actual reading scores for the past documents. In generating the vector matrix, the method further comprises calculating estimated reading scores for the recent documents based on the vector matrix, and populating second entries of the estimated reading matrix corresponding to the recent documents with the estimated reading scores. The method further comprises performing a factorization on the estimated reading matrix to generate a refined reading matrix, and generating recommendations of the recent documents to the users based on the refined reading matrix.

In another embodiment, calculating the estimated reading scores for the recent documents based on the vector matrix comprises calculating the estimated reading scores for the recent documents using a cosine-averaged algorithm.

In another embodiment, performing the factorization on the estimated reading matrix to generate the refined reading matrix comprises performing Nonnegative Matrix Factorization (NMF) to generate the refined reading matrix from the estimated reading matrix.

In another embodiment, performing the factorization on the estimated reading matrix to generate the refined reading matrix comprises performing Singular Value Decomposition (SVD) to generate the refined reading matrix from the estimated reading matrix.

In another embodiment, performing the factorization on the estimated reading matrix to generate the refined reading matrix comprises performing Lower-Upper (LU) decomposition to generate the refined reading matrix from the estimated reading matrix.

Another embodiment comprises a recommendation system that includes a means for identifying recent documents published within a time period preceding a present date, and for identifying historical information indicating consumption by users of past documents that were published prior to the time period. The recommendation system further comprises a means for generating a historical reading matrix based on the historical information, where the historical reading matrix has rows for the users, columns for the past documents, and entries that represent actual reading scores for the past documents. The recommendation system further comprises a means for generating a vector matrix for the recent documents and the past documents. The recommendation system further comprises a means for generating an estimated reading matrix based on the historical reading matrix and the vector matrix, where the estimated reading matrix has rows for the users, columns for the past documents and the recent documents, and first entries that represent the actual reading scores for the past documents. The recommendation system further comprises a means for calculating estimated reading scores for the recent documents based on the vector matrix, and for populating second entries of the estimated reading matrix corresponding to the recent documents with the estimated reading scores. The recommendation system further comprises a means for performing a factorization on the estimated reading matrix to generate a refined reading matrix, and for generating recommendations of the recent documents to the users based on the refined reading matrix.

Other embodiments may include computer readable media, other systems, or other methods as described below.

The above summary provides a basic understanding of some aspects of the specification. This summary is not an extensive overview of the specification. It is intended to neither identify key or critical elements of the specification nor delineate any scope of the particular embodiments of the specification, or any scope of the claims. Its sole purpose is to present some concepts of the specification in a simplified form as a prelude to the more detailed description that is presented later.

### DESCRIPTION OF THE DRAWINGS

Some embodiments of the invention are now described, by way of example only, and with reference to the accompanying drawings. The same reference number represents the same element or the same type of element on all drawings.

FIG. 1 illustrates a communication system in an illustrative embodiment.

FIG. 2 is a block diagram of a recommendation system in an illustrative embodiment.

FIG. 3 is a flow chart illustrating a method of recommending documents to users in an illustrative embodiment.

FIG. 4 is a block diagram illustrating a process flow for the recommendation system in an illustrative embodiment.

FIG. 5 illustrates a historical reading matrix in an illustrative embodiment.

FIG. 6 illustrates a vector matrix in an illustrative embodiment.

FIG. 7 illustrates an estimated reading matrix in an illustrative embodiment.

FIG. 8 illustrates the estimated reading matrix populated with estimated reading scores for recent documents in an illustrative embodiment.

### DESCRIPTION OF EMBODIMENTS

The figures and the following description illustrate specific exemplary embodiments. It will thus be appreciated that those skilled in the art will be able to devise various arrangements that, although not explicitly described or shown herein, embody the principles of the embodiments and are included within the scope of the embodiments. Furthermore, any examples described herein are intended to aid in understanding the principles of the embodiments, and are to be construed as being without limitation to such specifically recited examples and conditions. As a result, the inventive concept(s) is not limited to the specific embodiments or examples described below, but by the claims and their equivalents.

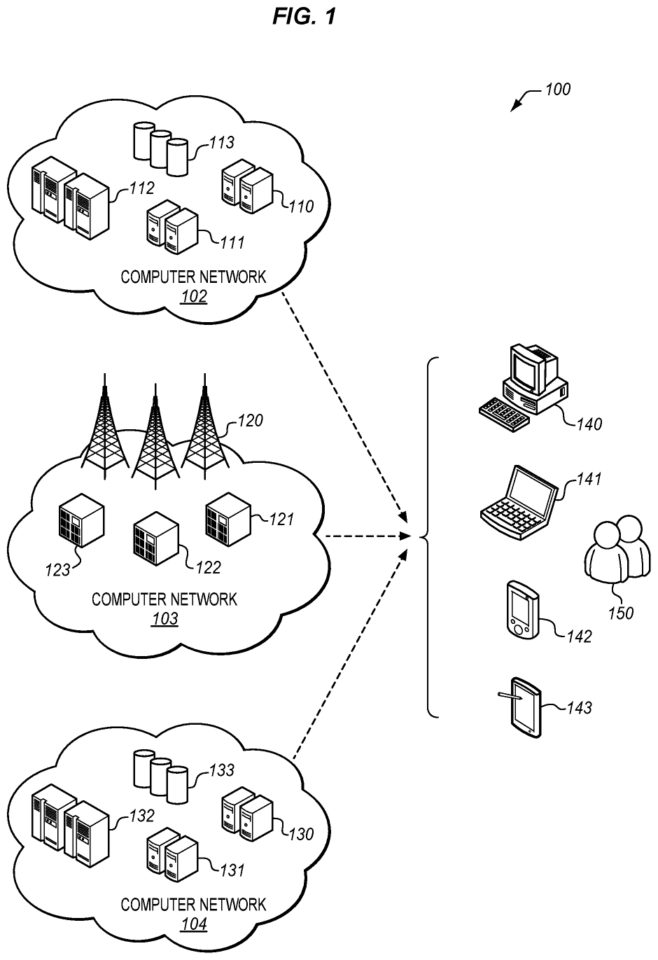

FIG. 1 illustrates a communication system 100 in an illustrative embodiment. Communication system 100 is a collection of one or more computer networks, transmission systems, user terminals, etc., that are configured for interconnection and interoperation to facilitate the transfer of data. One particular type of data described herein is referred to as “electronic documents” or “documents”, which comprise network-based content that is formatted for transfer over a network and configured for presentation on a user terminal. Examples of documents as described herein include web pages, articles, files (e.g., video, audio, etc.), email, etc. The documents may be text-based, or another type of document that may be converted into a vector space.

In this embodiment, communication system 100 includes one or more computer networks 102-104. A computer network 102-104 is a group of computer systems and other computing hardware devices that are linked together through communication channels to facilitate communication and resource-sharing among a wide range of users. Computer network 102 may represent an open or unsecure global computer network providing a variety of information and communication facilities through interconnected networks using standardized communication protocols, one example of which is the Internet. Computer network 102 may include web servers 110, mail servers 111, database servers 112, data stores 113, and/or other elements that store documents and/or facilitate the transfer of the documents. Computer network 103 may represent a mobile communication network (also referred to as a mobile network or cellular network) configured to communicate with user terminals via wireless signals. Computer network 103 may include cellular towers 120, switches 121, gateways 122, servers 123 and/or other elements that store documents and/or facilitate the transfer of the documents. Computer network 104 may represent a secure computer network, such as a corporate network or enterprise network, providing a variety of information and communication facilities through interconnected networks. An enterprise network is a group of computers, servers, or other devices connected together in a building or in a particular area, which are all owned by the same company, entity, institution, etc. Computer network 104 may include file servers 130, mail servers 131, database servers 132, data stores 133, and/or other elements that store documents and/or facilitate the transfer of the documents.

Communication system 100 also includes a variety of user terminals 140-143, which may also be referred to as User Equipment (UE) or end user devices. User terminals 140-143 are hardware devices that are used directly by users 150 (i.e., end users) to access a service made available by a server or serving element of a computer network. For example, user terminal 140 may represent a desktop computer, user terminal 141 may represent a laptop computer, user terminal 142 may represent a mobile phone (e.g., a smartphone), and user terminal 143 may represent a personal digital assistant (PDA). Through user terminals 140-143, users 150 are able to access a variety of documents from one or more of computer networks 102-104. For example, users 150 may access email from a mail server 111/131, may access web pages from a web server 110, may access files from a file server 112/130, etc.

The amount of new documents available to users 150 may be massive, and users 150 may not realistically be able to view all of the new documents. In the embodiments described herein, a recommendation system parses the new documents and recommends a subset of the new documents to users 150. Instead of developing a static profile for the users 150 as with prior systems, the recommendation system as described herein is adaptive and is able to change with topics, trends, etc., in the new documents.

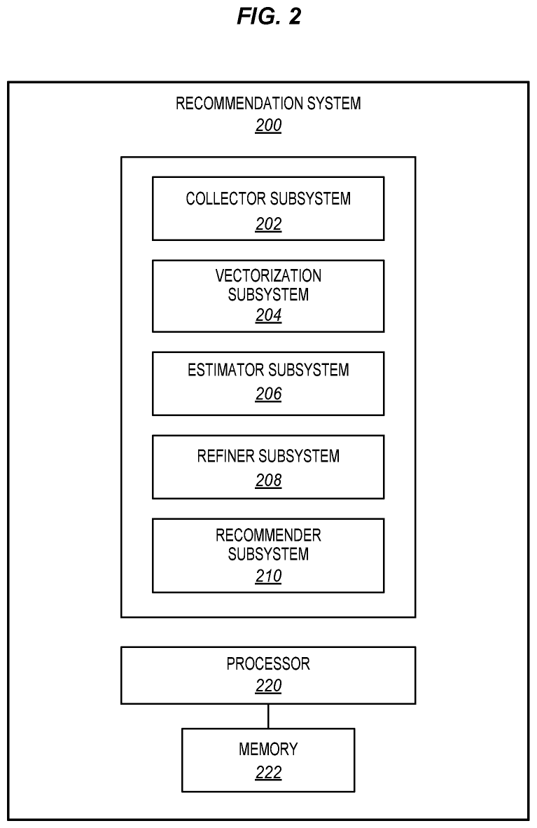

FIG. 2 is a block diagram of a recommendation system 200 in an illustrative embodiment. Recommendation system 200 is an information filtering system configured to predict the preferences of users in consuming or reading documents. Recommendation system 200 may be implemented in/with a user terminal (e.g., with a web browser, an email client, a file transfer client, etc.), a server in a computer network (e.g., a mail server, a web server, a file server, etc.), or intermediate elements.

In this embodiment, recommendation system 200 includes a collector subsystem 202, which comprises circuitry, hardware, or means configured to accumulate, receive, or acquire information regarding documents that are circulated, disseminated, published, or otherwise distributed by a computer network. Collector subsystem 202 may query a variety of servers to acquire the information, may subscribe to updates of the information, may receive information pushed by servers, etc. In this embodiment, collector subsystem 202 is configured to identify historical information indicating consumption by users of past documents (e.g., older than one day, two weeks, one month, two months, etc.), and is configured to identify new or recent documents (e.g., published within the last day, within two weeks, within one month, within two months, etc.).

Recommendation system 200 further includes a vectorization subsystem 204, which comprises circuitry, hardware, or means configured to vectorize the documents. Vectorization or vectorizing refers to the parsing of the documents to extract constituents (e.g., terms or words of a text-based document), and assigning values to the constituents, such as to indicate a degree or frequency of the constituents in the documents. In this embodiment, vectorization subsystem 204 is configured to vectorize the historical information and the recent documents to generate matrices. For example, vectorization subsystem 204 is configured to generate a historical reading matrix based on the historical information, and a vector matrix for the recent documents and the past documents.

Recommendation system 200 further includes an estimator subsystem 206, which comprises circuitry, hardware, or means configured to generate an estimated reading matrix based on the historical reading matrix and the vector matrix.

Recommendation system 200 further includes a refiner subsystem 208, which comprises circuitry, hardware, or means configured to perform a factorization on the estimated reading matrix to generate a refined reading matrix. Matrix factorization (also referred to as matrix decomposition) refers to the decomposition of a matrix (e.g., V) into smaller matrices (e.g., W and H), and then reconstructing a refined matrix (e.g., V′) from the product of the smaller matrices (V′=WH).

Recommendation system 200 further includes a recommender subsystem 210, which comprises circuitry, hardware, or means configured to generate recommendations of subsets of the recent documents to the users based on the refined reading matrix. Recommender subsystem 210 may provide the recommendations to servers over a network, may present the recommendations directly to a user, such as through a Graphical User Interface (GUI), etc. A GUI manages the interaction between a computer system and a user through graphical elements, such as windows on a display.

One or more of the subsystems of recommendation system 200 may be implemented on a hardware platform comprised of analog and/or digital circuitry. One or more of the subsystems of recommendation system 200 may be implemented on a processor 220 that executes instructions stored in memory 222. Processor 220 comprises an integrated hardware circuit configured to execute instructions, and memory 222 is a computer readable storage medium for data, instructions, applications, etc., and is accessible by processor 220.

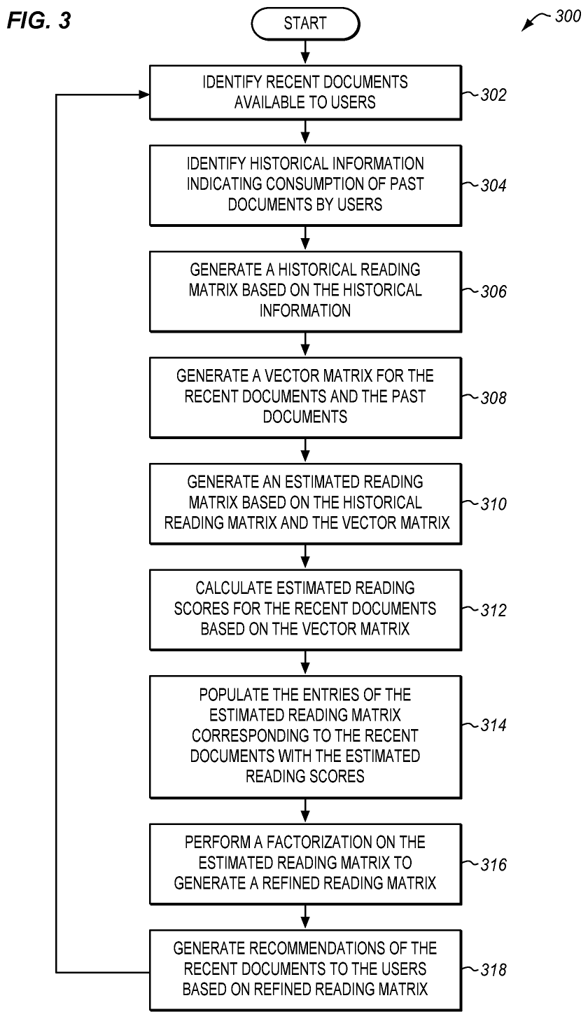

FIG. 3 is a flow chart illustrating a method 300 of recommending documents to users in an illustrative embodiment. The steps of method 300 will be described with reference to recommendation system 200 in FIG. 2, but those skilled in the art will appreciate that method 300 may be performed in other systems. Also, the steps of the flow charts described herein are not all inclusive and may include other steps not shown, and the steps may be performed in an alternative order.

For method 300, it is assumed that documents from one or more computer networks are available to a pool of users. For example, news articles may be available for viewing by the users over the Internet, via an enterprise network, through email, etc. The users may read, view, or otherwise consume the documents based on their preferences, such as by viewing the news articles of interest to them. The documents described herein may be divided into past documents and recent documents. Recent documents (or new documents) are defined as documents published or otherwise available to users within a time period preceding the present date (e.g., within the last day, within two weeks, within one month, within two months, etc.), so that the documents are new to the user or new in the time period. Past documents are defined as documents published or otherwise available to users prior to the time period (e.g., older than one day, two weeks, one month, two months, etc.).

Collector subsystem 202 identifies recent documents that were published or otherwise available to users (step 302). For example, the recent documents may be news articles made available during the time period. Collector subsystem 202 identifies historical information indicating consumption (e.g., reading or viewing) of past documents by users (step 304). The historical information indicates reading patterns or reading interactions for the past documents by the users. The historical information may include user identities for the users, the past documents consumed by the users or metadata for the past documents, ratings or scores for the past documents provided by the users, etc. Unlike the past documents, the recent documents most likely do not have associated information indicating reading patterns by the users.

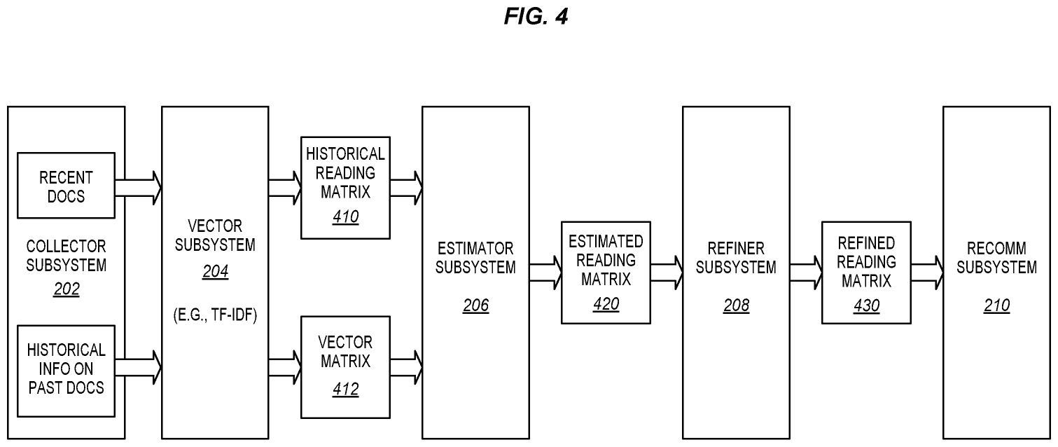

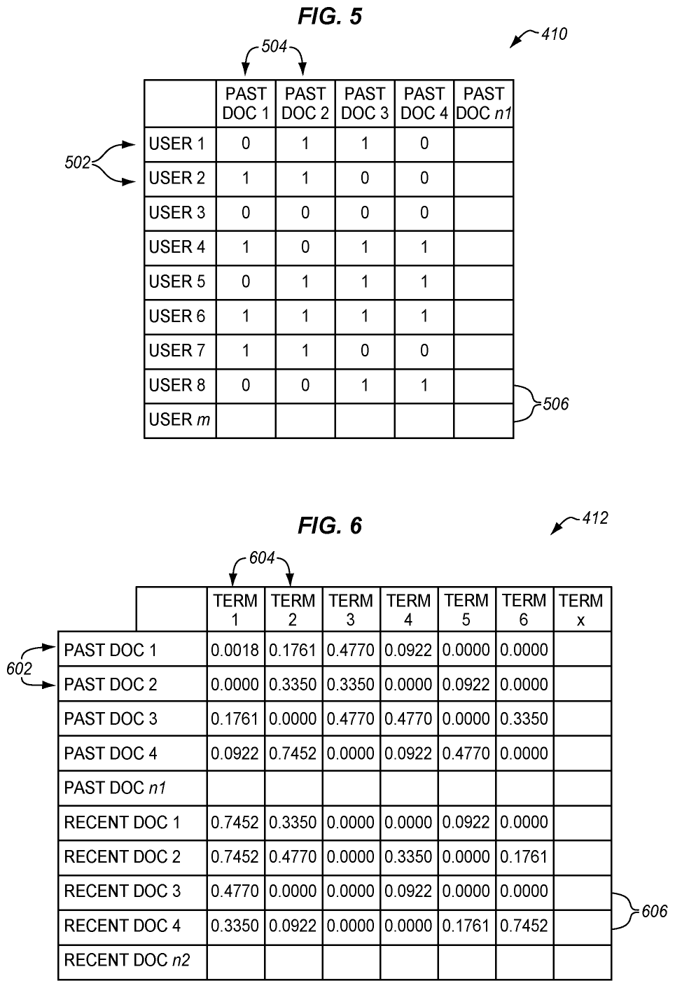

FIG. 4 is a block diagram illustrating a process flow for recommendation system 200 in an illustrative embodiment. As indicated in FIG. 4, collector subsystem 202 identifies recent documents and historical information on past documents. Collector subsystem 202 makes the documents/information available to vectorization subsystem 204. In FIG. 3, vectorization subsystem 204 generates a historical reading matrix 410 based on the historical information (step 306). FIG. 5 illustrates historical reading matrix 410 in an illustrative embodiment. Historical reading matrix 410 has rows 502 for the users, and columns 504 for the past documents. The entries 506 represent actual reading scores for the past documents, which are values reflecting whether or not a user read, viewed, or otherwise consumed the past document (e.g., a “0” if the user did not read the document, and a “1” if the user read the document), the interest of a user in consuming the document, etc. Historical reading matrix 410 in FIG. 5 is just one example, and may be transposed in other examples.

In FIG. 3, vectorization subsystem 204 also generates a vector matrix 412 for the recent documents and the past documents (step 308). FIG. 6 illustrates vector matrix 412 in an illustrative embodiment. Vector matrix 412 has rows 602 for the documents (past documents and recent documents), and columns 604 for the constituents parsed from the documents (e.g., terms from a text-based document). The entries 606 comprise values that are proportional to the number of times a constituent appears in the document, and is offset by the number of documents in the corpus having that constituent. For example, the values may be weighted values between 0 and 1. Vector matrix 412 in FIG. 6 is just one example, and may be transposed in other examples.

As indicated in FIG. 4, vectorization subsystem 204 may use Term Frequency-Inverse Document Frequency (TF-IDF) or other tools to generate vector matrix 412. TF-IDF is a tool used in natural language processing for converting text data into numerical vectors. Vectorization subsystem 204 may use TF-IDF to transform the recent documents and the past documents to their vector representation.

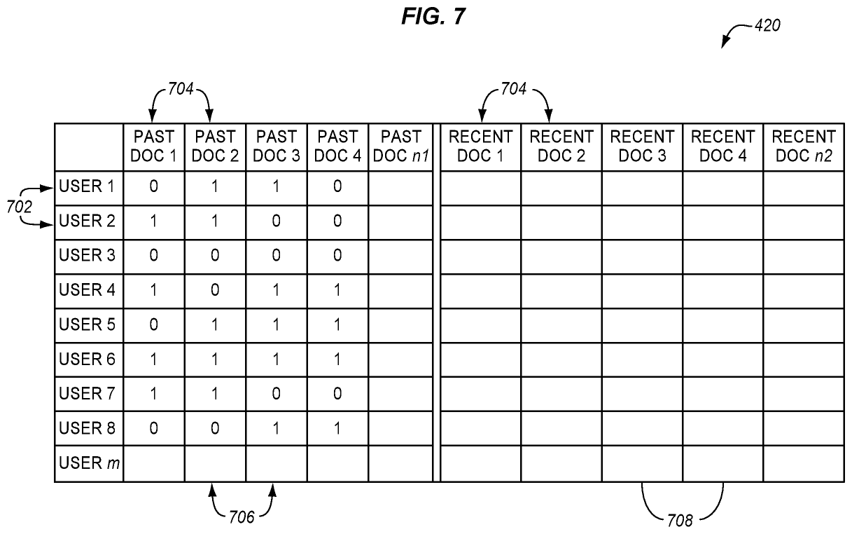

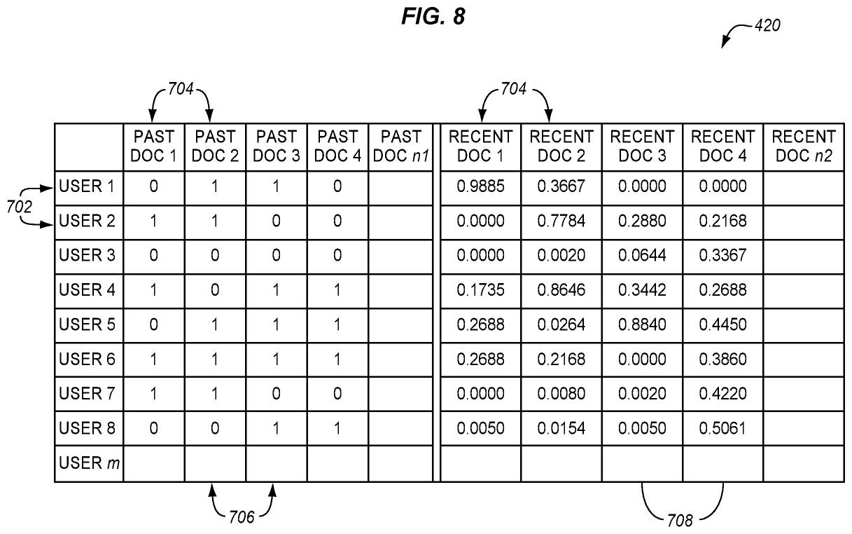

In FIG. 3, estimator subsystem 206 generates an estimated reading matrix 420 based on the historical reading matrix 410 and the vector matrix 412 (step 310). FIG. 7 illustrates estimated reading matrix 420 in an illustrative embodiment. Estimated reading matrix 420 has rows 702 for the users, and columns 704 for the past documents and the recent documents. Estimator subsystem 206 populates the entries 706 of estimated reading matrix 420, which correspond with the past documents, with the actual reading scores for the past documents from historical reading matrix 410. However, the entries 708 of estimated reading matrix 420 corresponding with the recent documents do not have values defined in historical reading matrix 410 because there was not a reading history for the recent documents. Thus, in generating estimated reading matrix 420, estimator subsystem 206 also calculates values for the recent documents.

In FIG. 3, estimator subsystem 206 calculates estimated reading scores for the recent documents based on the vector matrix 412 (step 312). This step approximates reading scores of users for recent documents that have not actually been read by the users. Estimator subsystem 206 populates the entries 708 of estimated reading matrix 420 corresponding to the recent documents with the estimated reading scores (step 314). FIG. 8 illustrates estimated reading matrix 420 populated with estimated reading scores for the recent documents in an illustrative embodiment. As illustrated, the entries 708 of estimated reading matrix 420 corresponding to the recent documents are populated with the estimated reading scores calculated by estimator subsystem 206. It is noted herein that although steps 310-314 are shown as separate steps in FIG. 3, they may be combined as a single step. In other words, the steps of calculating the estimated reading scores for the recent documents populating the entries 708 of estimated reading matrix 420 may occur when generating estimated reading matrix 420.

Estimator subsystem 206 may use a variety of techniques to calculate the estimated reading scores. In one embodiment, estimator subsystem 206 may use a cosine-averaged algorithm. One example of a cosine-averaged algorithm is as follows:

$${r}_{ua} = \frac{{\sum }_{{a}^{′} ∈ {A}_{p}} {r}_{{ua}^{′}}^{*} \times cosine ( a , {a}^{′} )}{{\sum }_{{a}^{′} ∈ {A}_{p}} {r}_{{ua}^{′}}^{*}} \qquad Equation 1$$

Equation 1 solves the estimated reading score rᵤₐ of a user u for a recent document a∈Aₙ. Aₚ represents a set of past documents, and Aₙ represents a set of recent documents. The term r*_{ua′} denotes the actual reading score of a user u for a past document a′∈Aₚ. Cosine(a, a′) is the cosine of two row vectors corresponding to document a and a′ from vector matrix 412. The rationale is that if a and a′ are similar, their corresponding row vectors from vector matrix 412 will be similar and cosine(a, a′) will be close to 1. Thus, if r*_{ua′} is high, then a will contribute to a high value towards rᵤₐ.

In another embodiment, estimator subsystem 206 may use different prediction or learning algorithms to calculate the estimated reading scores, such as Support Vector Machines (SVM), Deep Convolutional Neural Networks (CNN), etc.

In FIG. 3, refiner subsystem 208 performs a factorization on estimated reading matrix 420 to generate a refined reading matrix 430 (step 316). In one embodiment, refiner subsystem 208 may use Nonnegative Matrix Factorization (NMF) to generate refined reading matrix 430 from estimated reading matrix 420. NFM may be used because the quality of estimated reading matrix 420 is low if used directly for recommendations, and the NMF algorithm takes advantage of the low-dimensional approximation of estimated reading matrix 420 to factorize it into a product of two smaller nonnegative factor matrices, which are then reconstructed into refined reading matrix 430 by multiplying the smaller nonnegative factor matrices.

In other embodiments, refiner subsystem 208 may use other matrix decomposition algorithms, such as Singular Value Decomposition (SVD), Lower-Upper (LU) decomposition, etc.

Recommender subsystem 210 then generates recommendations of the recent documents to the users based on refined reading matrix 430 (step 318). For example, recommender subsystem 210 may generate a list of recent documents for a user as a recommendation for the user. Recommender subsystem 210 may send the list of recent documents to a server in the network, which in turn allows the server to present the list to the user. Recommender subsystem 210 may alternatively present the list of recent documents to the user, such as through a GUI. For instance, if recommendation system 200 is implemented in an email client, then it may present the list to the user through the email client. If recommendation system 200 is implemented in a web server or a web browser, then it may present the list to the user through the web browser.

Method 300 may subsequently be repeated as desired. When method 300 repeats at a later time, newly-published documents will be available and defined as “recent documents”. Also, the time period used to define the recent documents and the past documents shifts to a later date. For example, assume for one iteration of method 300 that the present date is December 1, and the time period is set at one week. For this iteration, the documents published before November 24 (i.e., more than a week before December 1) are defined as past documents, and the documents published after November 24 are defined as recent documents. Assume for another iteration of method 300, that the present date is December 10, and the time period is again set at one week. For this iteration, the documents published before December 3 (i.e., more than a week before December 10) are defined as past documents, and the documents published after December 3 are defined as recent documents. Thus, newly-published documents are designated as “recent documents” over time, and some documents may transition from being designated as “recent documents” to “past documents”, which grows the corpus of past documents. Also, actual reading scores may be assigned to the documents that transition into “past documents” as they are consumed by the users. When method 300 is executed again at later dates, the refined reading matrix evolves based on the documents added to the corpus of past documents.

One benefit of recommendation system 200 is computational speed. In contrast to other machine learning algorithms, which easily take hours or days for running, recommendation system 200 performs calculations in a fraction of that time. This allows for real-time recommendations. Another benefit is that recommendation system 200 does not rely on a static profile of a user in making recommendations. Recommendation system 200 is adaptive in that the metrics for its computations change over time. Recommendation system 200 uses a sliding “present date” and time period to define what is a recent document and what is a past document. By doing so, the model used by recommendation system 200 changes based on how users consume the documents over time.

Any of the various elements or modules shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non-volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

As used in this application, the term “circuitry” may refer to one or more or all of the following:

(a) hardware-only circuit implementations (such as implementations in only analog and/or digital circuitry);

(b) combinations of hardware circuits and software, such as (as applicable):
(i) a combination of analog and/or digital hardware circuit(s) with software/firmware; and
(ii) any portions of hardware processor(s) with software (including digital signal processor(s)), software, and memory(ies) that work together to cause an apparatus, such as a mobile phone or server, to perform various functions); and

(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although specific embodiments were described herein, the scope of the disclosure is not limited to those specific embodiments. The scope of the disclosure is defined by the following claims and any equivalents thereof

What is claimed is:

1. A recommendation system, comprising:
first circuitry configured to identify recent documents published within a time period preceding a present date, and to identify historical information indicating consumption by users of past documents that were published prior to the time period;
second circuitry configured to generate a historical reading matrix based on the historical information, wherein the historical reading matrix has rows for the users, columns for the past documents, and entries that represent actual reading scores for the past documents;
the second circuitry is further configured to generate a vector matrix for the recent documents and the past documents;
third circuitry configured to generate an estimated reading matrix based on the historical reading matrix and the vector matrix, wherein the estimated reading matrix has rows for the users, columns for the past documents and the recent documents, and first entries that represent the actual reading scores for the past documents;
the third circuitry, in generating the estimated reading matrix, is further configured to calculate estimated reading scores for the recent documents based on the vector matrix, and to populate second entries of the estimated reading matrix corresponding to the recent documents with the estimated reading scores;
fourth circuitry configured to perform a factorization on the estimated reading matrix to generate a refined reading matrix; and
fifth circuitry configured to generate recommendations of the recent documents to the users based on the refined reading matrix.

2. The recommendation system of claim 1 wherein:
the third circuitry is configured to calculate the estimated reading scores for the recent documents using a cosine-averaged algorithm.

3. The recommendation system of claim 2 wherein the cosine-averaged algorithm comprises:
$${r}_{ua} = \frac{{\sum }_{{a}^{′} ∈ {A}_{p}} {r}_{{ua}^{′}}^{*} \times cosine ( a , {a}^{′} )}{{\sum }_{{a}^{′} ∈ {A}_{p}} {r}_{{ua}^{′}}^{*}}$$
where “rᵤₐ” represents an estimated reading score of a user “u” for a recent document “a” within a set of recent documents “Aₙ”, “Aₚ” represents a set of past documents, and “r_{ua′}” represents the actual reading score of a user “u” for a past document “a′” within the set of documents “Aₚ”.

4. The recommendation system of claim 1 wherein:
the fourth circuitry is configured to use Nonnegative Matrix Factorization (NMF) to generate the refined reading matrix from the estimated reading matrix.

5. The recommendation system of claim 1 wherein:
the fourth circuitry is configured to use Singular Value Decomposition (SVD) to generate the refined reading matrix from the estimated reading matrix.

6. The recommendation system of claim 1 wherein:
the fourth circuitry is configured to use Lower-Upper (LU) decomposition to generate the refined reading matrix from the estimated reading matrix.

7. The recommendation system of claim 1 wherein:
the fifth circuitry is configured to present the recommendations of the recent documents to at least one of the users through a Graphical User Interface (GUI).

8. A method of recommending documents to users, the method comprising:
identifying recent documents published within a time period preceding a present date;
identifying historical information indicating consumption by users of past documents that were published prior to the time period;
generating a historical reading matrix based on the historical information, wherein the historical reading matrix has rows for the users, columns for the past documents, and entries that represent actual reading scores for the past documents;
generating a vector matrix for the recent documents and the past documents;
generating an estimated reading matrix based on the historical reading matrix and the vector matrix, wherein the estimated reading matrix has rows for the users, columns for the past documents and the recent documents, and first entries that represent the actual reading scores for the past documents;
calculating estimated reading scores for the recent documents based on the vector matrix;
populating second entries of the estimated reading matrix corresponding to the recent documents with the estimated reading scores;
performing a factorization on the estimated reading matrix to generate a refined reading matrix; and
generating recommendations of the recent documents to the users based on the refined reading matrix.

9. The method of claim 8 wherein calculating the estimated reading scores for the recent documents based on the vector matrix comprises:
calculating the estimated reading scores for the recent documents using a cosine-averaged algorithm.

10. The method of claim 9 wherein the cosine-averaged algorithm comprises:
$${r}_{ua} = \frac{{\sum }_{{a}^{′} ∈ {A}_{p}} {r}_{{ua}^{′}}^{*} \times cosine ( a , {a}^{′} )}{{\sum }_{{a}^{′} ∈ {A}_{p}} {r}_{{ua}^{′}}^{*}}$$
where “rᵤₐ” represents an estimated reading score of a user “u” for a recent document “a” within a set of recent documents “Aₙ”, “Aₚ” represents a set of past documents, and “r*_{ua′}” represents the actual reading score of a user “u” for a past document “a′” within the set of documents “Aₚ”.

11. The method of claim 8 wherein performing the factorization on the estimated reading matrix to generate the refined reading matrix comprises:
performing Nonnegative Matrix Factorization (NMF) to generate the refined reading matrix from the estimated reading matrix.

12. The method of claim 8 wherein performing the factorization on the estimated reading matrix to generate the refined reading matrix comprises:
performing Singular Value Decomposition (SVD) to generate the refined reading matrix from the estimated reading matrix.

13. The method of claim 8 wherein performing the factorization on the estimated reading matrix to generate the refined reading matrix comprises:
performing Lower-Upper (LU) decomposition to generate the refined reading matrix from the estimated reading matrix.

14. A non-transitory computer readable medium embodying programmed instructions executed by one or more processors, wherein the instructions direct the processors to implement a method of recommending documents to users, the method comprising:
identifying recent documents published within a time period preceding a present date;
identifying historical information indicating consumption by users of past documents that were published prior to the time period;
generating a historical reading matrix based on the historical information, wherein the historical reading matrix has rows for the users, columns for the past documents, and entries that represent actual reading scores for the past documents;
generating a vector matrix for the recent documents and the past documents;
generating an estimated reading matrix based on the historical reading matrix and the vector matrix, wherein the estimated reading matrix has rows for the users, columns for the past documents and the recent documents, and first entries that represent the actual reading scores for the past documents;
calculating estimated reading scores for the recent documents based on the vector matrix;
populating second entries of the estimated reading matrix corresponding to the recent documents with the estimated reading scores;
performing a factorization on the estimated reading matrix to generate a refined reading matrix; and
generating recommendations of the recent documents to the users based on the refined reading matrix.

15. The computer readable medium of claim 14 wherein calculating the estimated reading scores for the recent documents based on the vector matrix comprises:
calculating the estimated reading scores for the recent documents using a cosine-averaged algorithm.

16. The computer readable medium of claim 15 wherein the cosine-averaged algorithm comprises:
$${r}_{ua} = \frac{{\sum }_{{a}^{′} ∈ {A}_{p}} {r}_{{ua}^{′}}^{*} \times cosine ( a , {a}^{′} )}{{\sum }_{{a}^{′} ∈ {A}_{p}} {r}_{{ua}^{′}}^{*}}$$
where “rᵤₐ” represents an estimated reading score of a user “u” for a recent document “a” within a set of recent documents “Aₙ”, “Aₚ” represents a set of past documents, and “r*_{ua′}” represents the actual reading score of a user “u” for a past document “a′” within the set of documents “Aₚ”.

17. The computer readable medium of claim 14 wherein performing the factorization on the estimated reading matrix to generate the refined reading matrix comprises:
performing Nonnegative Matrix Factorization (NMF) to generate the refined reading matrix from the estimated reading matrix.

18. The computer readable medium of claim 14 wherein performing the factorization on the estimated reading matrix to generate the refined reading matrix comprises:
performing Singular Value Decomposition (SVD) to generate the refined reading matrix from the estimated reading matrix.

19. The computer readable medium of claim 14 wherein performing the factorization on the estimated reading matrix to generate the refined reading matrix comprises:
performing Lower-Upper (LU) decomposition to generate the refined reading matrix from the estimated reading matrix.

20. The computer readable medium of claim 14 wherein generating the recommendations of the recent documents further comprises:
presenting the recommendations of the recent documents to at least one of the users through a Graphical User Interface (GUI).
